(19) United States
(12) Patent Application Publication
(10) Pub. No.: US 2007/0214189 A1
(43) Pub. Date: Sep. 13, 2007

(54) SYSTEM AND METHOD FOR CONSISTENCY CHECKING IN DOCUMENTS

(75) Inventor: Michael E. Groble, Lake Zurich, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,687

(22) Filed: Mar. 10, 2006

(51) Int. Cl. G06F 17/30

(52) U.S. Cl. 707/201

(57) ABSTRACT

A domain model (104) is created. The domain model (104) specifies a relationship between a first attribute and a second attribute. A requirements document (106) is parsed. As the requirements document (106) is parsed, at least one usage of the first attribute with the second attribute is located within the requirements document (106). A mapping is also provided between the first attribute, second attribute, and the relationship in the domain model (104). Thereafter, the at least one usage of the first attribute with the second attribute is compared to the relationship. Based upon the comparison, a correctness of the at least one usage in the requirements document (106) is determined.

### FIELD OF THE INVENTION

The field of the invention relates to examining documents and, more specifically, to consistency checking of attributes used in documents.

### BACKGROUND OF THE INVENTION

Various types of documents are used by scientists, engineers, and others to design, build, and test different types of systems, for instance, telecommunication systems. One such document is generally referred to as a requirements document.

Requirement documents are often used during the design process to document required high-level system features or capabilities of the system. In addition, requirements documents sometimes provide low-level information such as data or procedure definitions, types, and usages. The information contained in requirements documents is often included or cross-referenced in other documents or other media. For instance, the procedure or type definitions that appear in requirements documents also often appear in other types of documents used in the design process.

Consistency in the definition and usage of attributes used in requirements or other types of documents is often a concern. For instance, multiple authors of these documents often utilize different terms for the same attribute or use the same term for an attribute, but in inconsistent ways. If the usage or definition of an attribute used in a requirements document is inconsistent with the usage or definition of the attribute in another document, a system designer may make false assumptions or improper design choices. Confusion on the part of the reader also often results from these problems.

Unfortunately, previous approaches have not adequately addressed the problem of providing adequate consistency checking between requirements documents and other types of documents. At best, these approaches rely on manual (e.g., visual) cross-checking and comparisons between the requirements document and the other documents and/or the memory of the designer to ensure that the proper consistency is maintained and that the attributes are used correctly. Even when done properly, manual checking was often slow and cumbersome to perform. Consequently, design mistakes were sometimes made and these mistakes resulted in increased system costs as these mistakes had to be later corrected.

### BRIEF DESCRIPTION OF THE DRAWINGS

FIG. 1 is a block diagram of a system for providing consistency checking according to embodiments of the present invention;

FIG. 2 is a flowchart of one approach for providing consistency checking according to embodiments of the present invention;

FIG. 3 is one example of a data model that is used to provide consistency checking according to the present invention;

FIG. 4 is one example of a screen showing feedback provided to the user according to embodiments of the present invention; and

FIG. 5 is one example of the functional components in memory and the controller according to embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method are provided that allow consistency checking to be performed in requirements and other types of documents. The approaches provided herein provide for the automatic determination as to whether certain attributes are used appropriately, consistently, and/or correctly within a requirements document. Automatic feedback may be provided to the user to highlight inconsistent or inappropriate usage of the attributes. Reader confusion caused by the inconsistent or improper usage of attributes is reduced and design mistakes that may occur as a result of inconsistent or inappropriate attribute usage are reduced or eliminated.

In many of these embodiments, a domain model is obtained. The domain model, which may be stored in a memory storage device, specifies a relationship between a first attribute and a second attribute. A requirements document is also parsed. As the requirements document is parsed, the usage of the first attribute together with the second attribute is located. A mapping is also provided between the first attribute, second attribute, and the relationship in the stored domain model. Thereafter, the at least one usage of the first attribute with the second attribute is compared to the relationship using the mapping. Based upon the comparison, it is determined whether the first attribute has been used correctly or appropriately.

The domain model can be obtained in a number of different ways. For instance, a preprogrammed data structure representing the domain model may be received and stored in the memory storage device. In another example, the domain model may be dynamically created by parsing the text of one or more documents and forming the domain model based upon the information that was obtained from parsing the documents. Thereafter, the domain model may be stored in a data structure in the memory storage device.

In others of these embodiments, feedback is provided to a user concerning the results of the comparison so as to alert the user to incorrect or inappropriate usage of attributes in the requirements document. The feedback may take a variety of forms. For example, the feedback may include syntax highlighting, substantially immediate error feedback messages, semantic completions, disambiguation feedback messages, on-demand documentation messages, automated hyperlink feedback messages, refactoring feedback messages, or semantic searches. Other examples of feedback are possible.

Thus, a system and method are provided that allow consistency checking to be performed for attributes used in requirements or other types of documents. The approaches provided herein facilitate the automatic determination as to whether attributes are used appropriately, consistently, and/or correctly within a requirements document. Feedback is also provided to the user in order to alert the user of incorrect or inappropriate attribute usage. In so doing, reader confusion and design errors are reduced or eliminated.

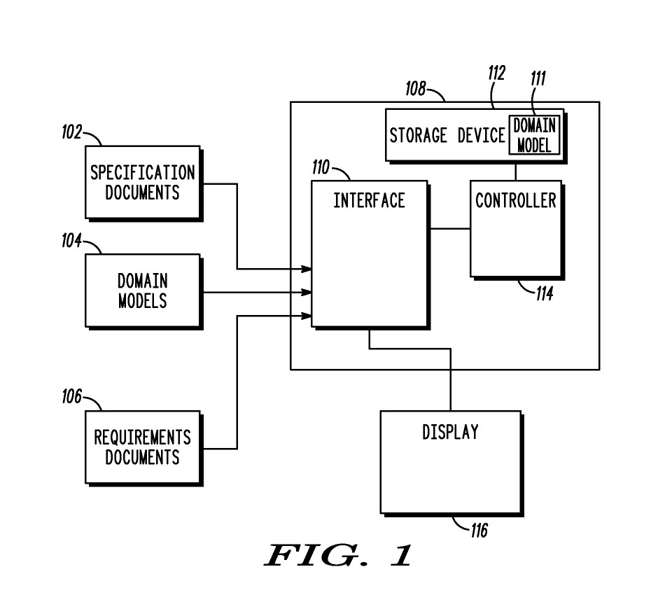

Referring now to FIG. 1, one example of a system for providing consistency checking for attributes in documents (e.g., requirements documents) is described. A document processing device 101 receives (as input) specification documents 102, domain models 104, and requirements documents 106. Preferably, the inputs are in electronic form so as to be searchable using conventional data processing techniques. The specification documents 102, domain models 104, and requirements documents 106 are received at an interface 110 within the document processing device 101. A controller 114 within the document processing device 101 processes the documents 102, 106, and/or domain models 104, selectively forms a domain model (if not provided), and stores the data model in a memory storage device 1 12. The domain models 104 comprise rules that are used to determine whether the attributes (e.g., names, tags, terms, or phrases) present within a requirements document are used consistently and/or correctly.

The controller 114 is also coupled to a display device 116 via the interface 1 10. The display device 116 may be any type of device used to display information to a user concerning the results of the consistency checking. In one example, the controller 114 is provided with a wired connection to the display device 116, which is a personal computer. However, the display device 116 may also be any type or combination of any type of device used to provide information to a user such as a cellular phone, pager or personal digital assistant. In addition, the connection between the controller 114 and the display device 116 can be wired, wireless, fiber, or use any other type of suitable connection technology.

The interface 110 is any device or combination of device that is used to receive different types of documents or input from outside sources. In this regard, the interface 110 may perform formatting or buffering functions on the received information that are well known to those skilled in the art and will not be discussed further herein.

In one example, the domain models 104 may be created dynamically. In this case, the specification document 102 includes information (e.g., text, tables) that is processed and used to form the domain models 104. The domain models 104 may then be stored in the storage device 112.

In another example, the domain models 104 may be preprogrammed data structures that are received by the device 101. These data structures may be stored in any appropriate format according to any appropriate programming language.

As mentioned, the domain models 104 specify rules that determine whether an attribute is being used correctly between documents. More specifically, the domain model 104 may provide information such as names, the relationships between names (e.g. which interfaces are realized by a particular element, which messages exist within a particular interface, which parameters exist within a particular message and so forth). In addition to the domain model 104, a knowledge base 105 may also be provided to be a repository of stored names discovered in the supporting documentation and models as these items are parsed.

The domain model 104 and the knowledge base 105 may have a predefined and structured representation. This structure can be formalized in a number of different ways, for example, using metamodel representations, extensible markup language (XML) schemas, relational schemas or ontologies. Other examples of structures and representations are possible.

The requirements document 106 is a document specifying various technical requirements of a system and is input into the device 101 so that various terms may be checked for consistency and/or correct usage by the system. In one example, the knowledge base 105 becomes an instance of this metamodel as built from existing specification documents and/or specification models.

A requirements editor uses the knowledge base to assist a user in creating correct and consistent requirements. The editor parses the natural language requirements text as the text is being edited. The requirements document is parsed to determine named entities as when building the knowledge base.

The system may be configured with predicate information and semantic role labeling may be used to identify arguments in text and assign semantic tags to the arguments for recognized predicates. For instance, the predicate “send” may be associated with the tags Arg0 (“sender”), Arg1 (“things sent”), and Arg2 (“receiver”). The ordering of the tags may follow a general scheme (e.g. Arg0 may be the subject and Arg1 the direct object). In addition, each tag may be given a specific semantic meaning (e.g. Arg0 is the sender).

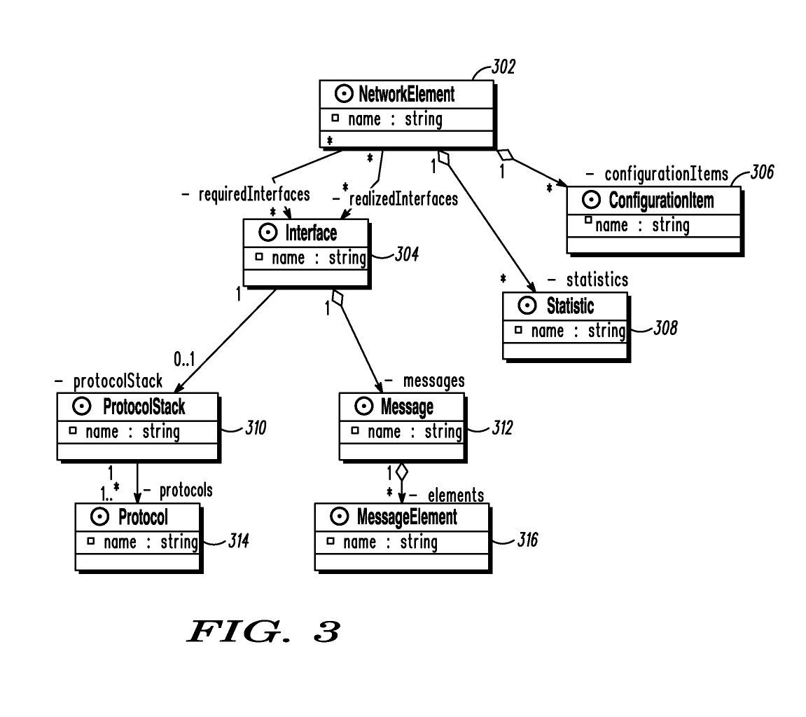

To use semantic role labeling, the system may provide a mapping of tags to objects in the domain model. For example (and using the domain model of FIG. 3 as an example), the Arg1 tag of the predicate “send” may be mapped to the domain model object “Message” since messages are sendable items. Consequently, semantic role labeling and mapping provides one approach for facilitating the comparison of parsed text from a requirements document and information in the domain model.

In one example of the operation of the system of FIG. 1, the domain model 104 is obtained. As mentioned, the domain model 104 can be obtained in a variety of different ways. For instance, a preprogrammed data structure 104 representing the domain model may be received and stored in the memory storage device 112. In another example, the domain model 104 may be dynamically created by parsing text of at least one document (e.g., specification documents 102) and forming the domain model 104 based upon the parsing. Thereafter, the domain model 111 may be stored in a data structure in a memory storage device 112.

A requirements document 106 is then parsed by the editor. As the requirements document 106 is parsed, at least one usage of a first attribute with a second attribute is located. A mapping is also provided between the first attribute, second attribute, and the relationship in the domain model 111.

Thereafter, using the mapping, the usage of the first attribute with the second attribute is compared to the relationship. Based upon the comparison, it is determined whether the attribute has been used correctly.

Feedback to a user concerning the results of the comparison may be provided, for example, using the display 116. The feedback may take a variety of forms. For example, the feedback may include syntax highlighting, substantially immediate error feedback messages, semantic completions, disambiguation feedback messages, on-demand documentation messages, automated hyperlink feedback messages, refactoring feedback messages, or semantic searches. Other examples of feedback are possible. In addition, other types of devices besides a display may also used to provide the feedback.

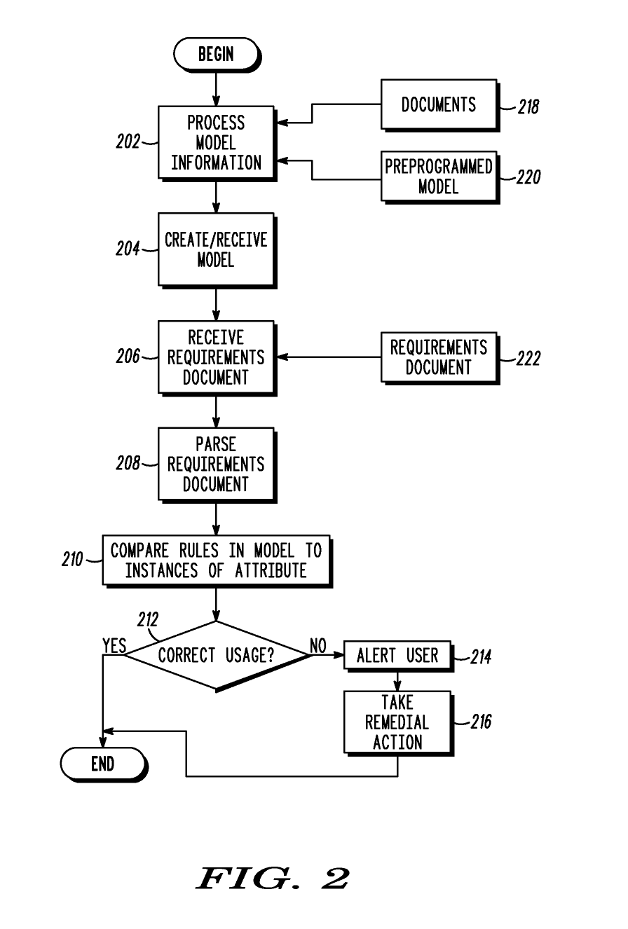

Referring now to FIG. 2, one example of an approach for providing consistency checking for attributes in documents is described. At step 202, domain model information is processed. The processing may include receiving documents 218, parsing these documents for information, and creating a domain model using the information. Alternatively, the processing may include receiving a pre-programmed domain model 220.

At step 204, a domain model is created (if a pre-programmed model is not received) and is stored in memory. If the system was supplied with the preprogrammed domain model 220, the preprogrammed domain model 220 is stored in memory. The domain model that is created or received specifies rules of usage for attributes. For example, the domain model may specify that certain attributes are to be used or associated with other specific attributes. In another, the domain model may indicate that various attributes are not properly associated with certain other attributes.

At step 206, the system receives a requirements document 222. The requirements document 222 contains attributes that have relationships with respect to one another. A list of attributes to search for in the requirements document may also be received. Alternatively, a user may indicate through an interface device particular attributes to be checked for consistency. In still another example, the system may check all attributes and usages between these in the requirements document. In yet another example, the system may check attributes between certain pages or at other certain locations within the requirements document.

At step 208, the requirements document is parsed. The parsing may be made by a computer editor or the like that identifies instances of the attributes and the relationships between these attributes. At step 210, a comparison is made between the rules in the domain model and the instances of the attributes identified during the parsing. At step 212, it is determined whether the particular usage determined from the parsing was correct. If the answer is affirmative at step 212, then execution ends. If the answer at step 212 is negative, then at step 214 the user is alerted to the incorrect usage.

As mention previously, the alerting of the user may include taking several different actions. For instance, the alerting may include syntax highlighting, substantially immediate error feedback messages, semantic completions, disambiguation feedback messages, on-demand documentation messages, automated hyperlink feedback messages, refactoring feedback messages, or semantic searches. At step 216, remedial action is taken by the system or the user. For instance, the user may correct the incorrect usage by deleting the incorrect usage or changing the usage to make the usage correct. Other remedial actions may also be taken.

Referring now to FIG. 3, one example of a domain model 300 is described. In one example, the domain model 300 may be a preprogrammed data model that is contained in an appropriate data structure. Alternatively, the system may create the domain model 300 by parsing various documents and creating a domain model using an appropriate data structure.

The domain model 300 includes a plurality of attributes 302, 304, 306, 308, 310, 312, and 316. Each of the attributes includes a field indicating the name of the attribute and pointers that specify relationships with the other attributes (or the absence of pointers indicating the absence of a relationship). For example, the attribute 302 has a name field “Network element” and has pointers to a first attribute 304 (“interface”), a second attribute 306 (name “Configuration item”), and a third attribute 308 (“statistic”). Consequently, it can be observed from FIG. 3 that instances of the attribute “network element” are related to attributes “interface,” “configuration,” and “statistic.” Alternatively, it can be seen that instances of attribute 308 (“statistic”) are not related to instances of a fourth attribute 312 (“message”).

A comparison of relationships presented in a requirements document to the rules specified in the domain model 300 will determine whether the instance as it is used in the requirements document is correct. For example, an editor may parse a requirements document and determine that the term “message” and “statistic” are used together. However the editor will examine the rules in the domain model and determine that there is no relationship between the terms “message” and “static.” Consequently, a determination will be made that the usage is incorrect. Feedback may be provided to the user informing the user that the usage is incorrect.

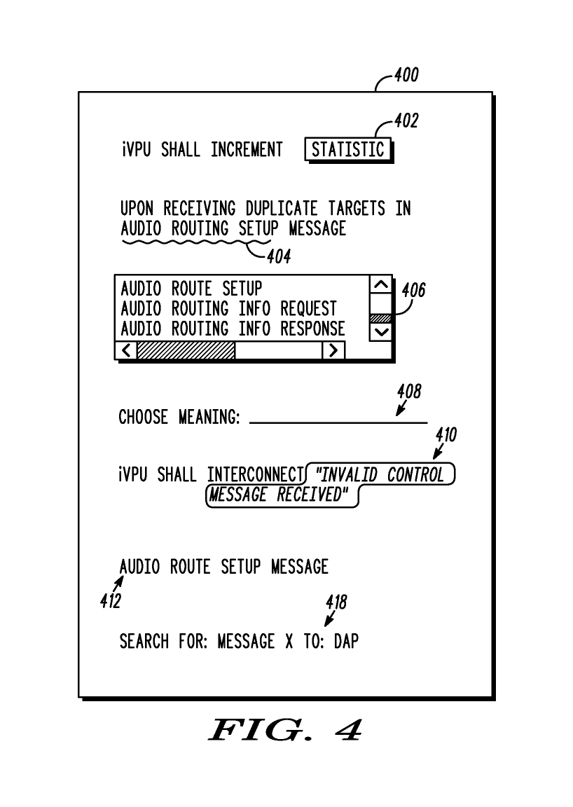

Referring now to FIG. 4, one example of feedback on a screen 400 provided to users is shown. It will be realized that for illustration purposes various types of feedback are shown in FIG. 4. However, the number and types of feedback shown in FIG. 4 can be altered according to the needs or preferences of the user.

In one example, syntax highlighting 402 is made in various colors to show terms that are stored in the domain model. For instance, the term “statistic” may be color highlighted to indicate that “statistic” exists in the domain model.

Immediate error feedback may also be provided. In this case, the editor detects noun phrases or arguments as they are typed by a user, and annotates the text based upon the absence of the phrase or argument from the domain model. For instance, underlining 404 indicates that the term “audio routing setup” is not a valid name.

Semantic completion may also be used to provide feedback. In this case, a context list 406 of completions may be provided. Typing the combinations after typing “Audio” results in the list 406.

Disambiguation may also be provided to resolve name collisions. For instance, a name can be used in different contexts (same name for message element and a statistic) or the domain model may contain redundant information. In these situations, it is desirable to determine which context the user desires. When a named entity has multiple entries in the domain model, the system uses a prompt 408 to request that the user choose the specific meaning of the term.

The system may also allow the ability to define aliases. A user may choose an unresolved name and choose an alias action. The system may allow the user to choose an existing named entity from the knowledge base. In one example, an alias 410 may appear in italics.

On-demand documentation may also be used to provide feedback to a user. For example, hovering a cursor over a statistic name could display the text defined within the statistic department of a corresponding table entry that defines the statistic.

Automatic hyper-linking may also be provided. For any recognized attribute, the user may retrieve documentation that is the defining declaration of the source. For example, clicking on defining declaration 412 may retrieve a corresponding document that includes the defining declaration of the attribute.

Semantic searching may also be used. In this case, the system allows the user to select a name and be able to initiate various types of searches. For example, a search may be performed to find all uses of the attribute in the requirements document. In another example, a metaobject-scope search may be performed. In this case, an attribute may exist in multiple scopes and may have different metaobject mappings (e.g., the name of a statistic and message may be the same). With a metaobject-scope search, the user can search for instances of the attribute in only those cases where it refers to an object of the specified type. In still another example of a search, a predicate search may be performed. In this case, various predicate arguments can be constrained. For example, as shown in element 414, a search may be made for requirements that mention sending message X to the DAP.

Refactoring may also be provided. For instance, the system may allow the user to modify a name and propagate all instances of the name change to all known uses of the name.

Customization of the above-provided functions and mechanisms may also be provided. For example, domain model entries can be assigned their own iconic representation and syntax highlighting (e.g., statistics can have different visual appearances than message elements).

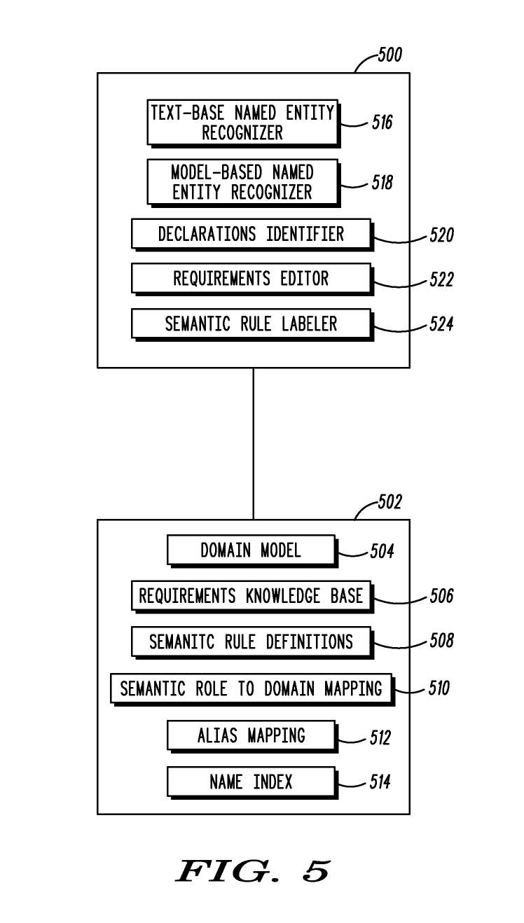

Referring now to FIG. 5, one example of the software and memory components of a system for consistency checking is described. The system includes a controller 500 and memory 502. In one example, the controller 500 may be the controller 114 in FIG. 1, and the memory 502 may be the storage device 112 also in FIG. 1.

The memory 502 includes a domain model 504, a requirements knowledge base 506, semantic role definitions 508, a semantic role to domain mapping 510, an alias mapping 512, and a name index 514. The controller 500 includes a text-based named entity recognizer 516, a model-based named entity recognizer 518, a declarations identifier 520, a requirements editor 522, and a semantic role labeler 524. These components cooperate as described below to facilitate the consistency checking functions described elsewhere in the specification.

The domain model 504 is a metamodel describing attributes and relationship between these attributes. The domain model 504 can be contained in any suitable data structure or construct according to any suitable computer programming language.

The requirements knowledge base 506 is a repository of typed or classified proper names discovered in the supporting documentation and models. The requirements knowledge base 506 is used to additional system functionality such as providing aliases. The semantic role definitions 508 contain a repository of predicate and semantic role definitions. In one example, the semantic role definitions 508 can be used to store semantic tag information as described elsewhere in this specification.

The semantic role to domain mapping 510 provides a data structure that maps predicate arguments to attributes in the domain model 504. The alias mapping 512 provides a repository of aliases defined by a user and maps the aliases to entities within the requirements knowledge base 506.

The name index 514 is an index (for search and refactoring purposes) of name usage in the knowledge base 506. The index 514 may reference the semantic tag and attribute associated with the tag to provide the required search and refactoring functionality.

Various software components support the functionality of the system. As mentioned previously, the requirements editor 522 is an editor that provides real-time semantic analysis of the requirements text and comparison of the text against the domain model and/or the knowledge base 506.

The requirements editor 522 may be comprised of and/or used together with additional software components. For example, the text-based named entity recognizer 516 may be provided to recognize proper names within natural language text passages and to classify names to attribute instances. In addition, the model-based named entity recognizer 518 may be used to recognize proper names within software models or data structures. Furthermore, the declarations identifier 520 may be used to identify which of the uses of a particular proper name is the one which is the “defining declaration” associated with that name and provide an associated hyperlink. Finally, the semantic role labeler 524 can be used to parse natural language text and identify predicates as well as the semantically typed arguments of those predicates.

Thus, system and method is provided that allows consistency checking to be performed for attributes in requirements or other types of technical description documents. The approaches provided herein allow the automatic determination as to whether certain terms are used appropriately, consistently, and/or correctly within a requirements document.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of providing consistency checking for requirements documents comprising:
creating a domain model that specifies a relationship between a first attribute and a second attribute;
parsing a requirements document and locating at least one usage of the first attribute with the second attribute in the requirements document;
providing a mapping between the first attribute, second attribute, and the relationship in the domain model;
comparing the at least one usage of the first attribute with the second attribute to the relationship; and
determining a correctness of the at least one usage in the requirements document based upon the comparing.

2. The method of claim 1 wherein creating a domain model comprises receiving a preprogrammed data structure of the domain model and storing the preprogrammed data structure in a memory storage device.

3. The method of claim 1 wherein creating a domain model comprises parsing text of at least one document and forming the domain model based upon the parsing and thereafter storing the domain model in a data structure in a memory storage device.

4. The method of claim 1 further comprising providing feedback to a user concerning a result of the comparing.

5. The method of claim 4 wherein providing the feedback comprises providing feedback selected from a group comprising: syntax highlighting, a substantially immediate error feedback message; a semantic completion; a disambiguation feedback message; an on-demand documentation message; an automated hyperlink feedback message; a refactoring feedback message; and a semantic search.

6. A method of providing consistency checking for requirements documents comprising:
parsing a requirements document to locate a textual attribute;
determining a usage of the textual attribute in a context of the requirements document;
accessing a domain model in a memory storage device and determining a correctness of the usage of the textual attribute in the requirements document by comparing the usage to an attribute usage rule represented in the domain model; and
communicating the correctness of the usage to a user.

7. The method of claim 6 wherein parsing the requirements document comprises parsing a requirements document and locating at least one type definition.

8. The method of claim 6 wherein communicating the correctness comprises alerting the user that the usage is at least potentially incorrect.

9. The method of claim 8 wherein alerting the user comprises issuing feedback to the user selected from a group comprising: syntax highlighting, a substantially immediate error feedback message; a semantic completion; a disambiguation feedback message; an on-demand documentation message; an automated hyperlink feedback message; a refactoring feedback message; and a semantic search.

10. The method of claim 6 further comprising performing a remedial action to correct the requirements document when the correctness is determined to be incorrect.

11. A device for providing consistency checking for requirements documents comprising:
a memory storage device having stored thereon a domain model that specifies an attribute usage rule;
an interface for receiving a requirements document;
a controller coupled to the storage device and the interface, the controller being programmed to parse the requirements document received at the interface, locate a usage of an attribute in the requirements document to provide a comparison, compare the usage to the attribute usage rule, and determine a correctness of the usage based upon the comparison.

12. The device of claim 11 wherein the domain model is a preprogrammed data structure.

13. The device of claim 11 wherein the controller is programmed to parse the text of at least one document received at the interface to form the domain model and, thereafter, to store the domain model in a data structure at the memory storage device.

14. The device of claim 11 wherein the controller is further programmed to provide feedback to a user concerning a result of the comparison.

15. The device of claim 14 wherein the controller is further programmed to provide feedback selected from a group comprising: syntax highlighting, a substantially immediate error feedback message; a semantic completion; a disambiguation feedback message; an on-demand documentation message; an automated hyperlink feedback message; a refactoring feedback message; and a semantic search.
